(19) United States
(12) Patent Application Publication
(10) Pub. No.: US 2017/0140662 A1
(43) Pub. Date: May 18, 2017

(54) WEARABLE COMPUTING DEVICE FOR YOUTH AND DEVELOPMENTALLY DISABLED

(71) Applicants: Erin Marie Carr-Jordan, Chandler, AZ (US); Annissa D. Furr, Peoria, AZ (US)

(72) Inventors: Erin Marie Carr-Jordan, Chandler, AZ (US); Annissa D. Furr, Peoria, AZ (US)

(21) Appl. No.: 14/941,635

(22) Filed: Nov. 15, 2015

(51) Int. Cl. G09B 19/00; G06F 3/041; G06F 3/01; G06F 19/00; G06F 3/0484; G06F 3/0482; G09B 5/02; G06F 1/16; G06F 3/14

(52) U.S. Cl. CPC G09B 19/00; G06F 1/163; G06F 3/0416; G06F 3/017; G06F 3/14; G06F 3/04842; G06F 3/0482; G09B 5/02; G09B 19/003; G06F 19/322

(57) ABSTRACT

The system of the preferred embodiments is a wearable computing device with a processor computer readable memory connected to the processor and designed for read and write operations from the processor software code stored in the computer readable memory a housing that is mounted to the processor and computer readable memory and enclosing the processor and computer readable memory a wrist band attached to the housing and designed to releasably attach the housing to a user's arm; a screen mounted to the top of the housing and designed to display output from the processor, where the screen is designed to receive input from a user's touch; a radio transmitter mounted to the housing and designed to transmit data to at least one remote device; where the software code is adapted to transmit data to the remote device related to one or more of A) the health of the user, B) the mental well-being of the user, C) the success of the user in sports, and D) the success of the user in academics, where the transmitted data is designed to help one or more of 1) a family member of the user, and 2) a supervisor of the user in caring for one or more of A) the health of the user, B) the mental well-being of the user, C) the success of the user in sports, and D) the success of the user in academics. The wearable computing device of the preferred embodiments is designed to allow one or more of parents, teachers, doctors, counselors, caretakers, and other family members to better care for a a user that cannot perfectly care for themselves due to one or more of age and disability, and the wearable computing device is further designed to help the user one or more of: live a more healthy life, succeed more in one or more of academics and athletics, find motivation and encouragement for getting through tasks related to one or more of the user's health, the user's academics, and the user's athletics.

### BRIEF DESCRIPTION OF THE FIGURES

FIG. 1 is a schematic representation of the system of the preferred embodiments, further including the transmission of data related to one or more of A) the health of the user, B) the mental health of the user, C) the academics of the user, and D) the athletic performance of the user, where the data is transmitted to a remote device that is accessible to at least one of 1) a family member of the user and 2) a supervisor of the user.

FIG. 2 is a schematic representation of the system of the preferred embodiments, further including pictorial representations of human emotions that can be selected by the user to represent their current emotional state, and where a remote database is accessible by at least one remote device.

FIG. 3 is a flow chart representation of the method for allowing the user to report their emotions in a variation of the first preferred embodiments.

FIG. 4 is a flow chart representation the system of the preferred embodiments, where the system includes an accelerometer and the output data of the accelerometer is at least one of 1) compared against one or more challenges the user may be undertaking, and 2) transmitted to a remote device for processing and comparison against at least one remote database.

FIG. 5 is a flow chart representation the system of the preferred embodiments, where the user inputs information related to their progress in a challenge, and the information is used to one or more of A) provide feedback related to the challenge to the user, and B) the data is used in a social network to share the progress of the challenge with other users of wearable computing devices.

FIG. 6 is a schematic representation of the system of the preferred embodiments, where the user is prompted to input information about their progress through a challenge.

### DESCRIPTION OF THE PREFERRED EMBODIMENTS

The following description of the preferred embodiments of the invention is intended to enable someone skilled in the prior art to make and use this invention, but is not intended to limit the invention to these preferred embodiments.

### 1. First Preferred Embodiment

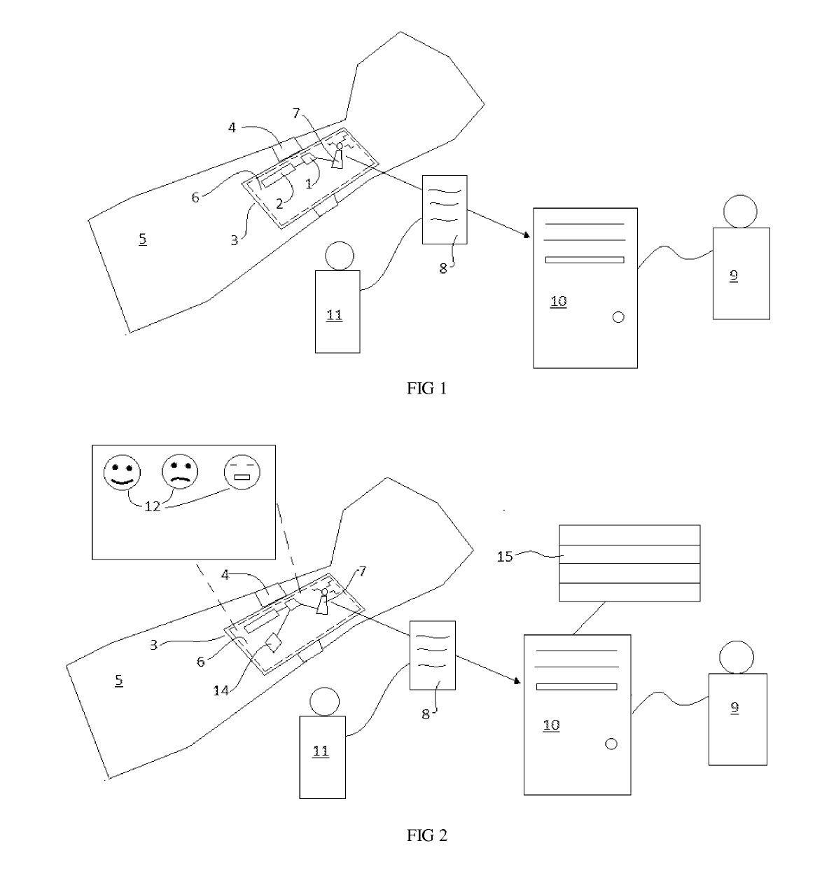

As shown in FIG. 1, the system of the preferred embodiments is a wearable computing device with a processor 1; computer readable memory 2 connected to the processor 1 and designed for read and write operations from the processor 1; software code stored in the computer readable memory 2; a housing 3 that is mounted to the processor 1 and computer readable memory 2 and enclosing the processor 1 and computer readable memory 2; a wrist band 4 attached to the housing 3 and designed to releasably attach the housing 3 to a user's arm 5; a screen 6 mounted to the top of the housing 3 and designed to display output from the processor 1, where the screen 6 is designed to receive input from a user's touch; a radio transmitter 7 mounted to the housing 3 and designed to transmit data to at least one remote device; where the software code is adapted to transmit data 8 to the remote device 10 related to one or more of A) the health of the user, B) the mental well-being of the user, C) the success of the user 11 in sports, and D) the success of the user 11 in academics, where the transmitted data is designed to help one or more of 1) a family member 9 of the user, and 2) a supervisor 9 of the user 11 in caring for one or more of A) the health of the user, B) the mental well-being of the user, C) the success of the user 11 in sports, and D) the success of the user 11 in academics. The wearable computing device of the preferred embodiments is designed to allow one or more of parents, teachers, doctors, counselors, caretakers, and other family members 9 to better care for a a user 11 that cannot perfectly care for themselves due to one or more of age and disability, and the wearable computing device is further designed to help the user 11 one or more of: live a more healthy life, succeed more in one or more of academics and athletics, find motivation and encouragement for getting through tasks related to one or more of the user's health, the user's academics, and the user's athletics.

As shown in FIG. 1, the system of the first preferred embodiments includes a housing 3 attached to a wrist band 4. The wrist band 4 is designed to releasably attach the housing 3 to the arm 5 of a user. The wrist band 4 may use any suitable means of releasable attachment in order to accomplish this, including but not limited to hook and loop fasteners, buckle and perforation type fasteners, snap fasteners, snap buckle fasteners, and any other suitable fasteners. The wrist band 4 may, however, not include a fastener. The wrist band 4 preferably includes a means for adjusting the circumference of the band to fit different users, however the wrist band 4 may not include any form of adjustment. In one preferred variation, the wrist band 4 is constructed from a material that is safe to be worn by users with one or more of skin allergies and skin sensitivities. Preferably these materials avoid are constructed to avoid trapping moisture against the skin of the user. Preferably these materials are further selected to avoid one or more of common skin allergies to materials and common skin sensitivities to materials. These materials may be selected to avoid inclusion of one or more of metals, latex, spandex, lycra, nylon, clothing dyes, P-phenylenediamine, phenol, formaldehyde, Colophony, chromium, and irritating curing agents including but not limited to isocyanates. In one preferred variation, the wrist band 4 is constructed from dye-free, untreated natural fibers. In another preferred variation the wrist band 4 is constructed from medical grade silicone rubber and textured to avoid trapping moisture. In this preferred variation the surface of the band may be textured to prevent significant areas of skin contact with smooth, flat material. In this preferred variation the surface of the wrist band 4 is textured with a number of high points and low points in a pattern that allows airflow and prevents continuous contact over a significant area of skin. In one variation a significant area of skin may be over a quarter square centimeter. In another variation a significant area of skin may be over a half square centimeter. In this preferred variation, perforations through the wrist band 4 may also be included to promote airflow to the skin of the user. The wrist band 4 may, however, be constructed of any suitable material.

The housing 3 is preferably constructed of a polymer material. In another preferred variation, the housing 3 may be constructed of a metal such as aluminum. Preferably the bottom of the housing 3 has a material attached to it that is safe for wearing by users with one or more of skin sensitivities and skin allergies, including but not limited to the materials discussed above. In another preferred variation, the housing 3 is made of materials safe for those with skin sensitivities. The housing 3 may, however, be constructed of any suitable material.

As shown in FIG. 1, a processor 1 is mounted in the housing 3. As shown in FIG. 1, computer readable memory 2 is also mounted in the housing 3 and is connected to the processor 1. The computer readable memory 2 is designed to receive read and write operations from the processor 1. Software code is stored on the computer readable memory 2, and the processor 1 carries out operations in the software code. As shown in FIG. 1, a screen 6 is mounted to the top of the housing 3. The screen 6 is preferably designed to receive touch input from the user. In another variation, the screen 6 is not touch sensitive and the wearable computing device receives user 11 input from a key pad. In another variation, the wearable computing device may receive input from means including but not limited to voice input, eye tracking, EEG readings of neurological impulses, other readings of nerve impulses, writing input, and video input. The wearable computing device may, however, receive input from any suitable means. As shown in FIG. 1, the wearable computing device further includes a radio transmitter 7 attached to the housing 3 and connected to one or more of the processor 1, a motherboard, and an integrated electronic circuit that incorporates the electronic components of the wearable computing device. The radio transmitter 7 is designed to transmit data 8 to at least one remote device.

As shown in FIG. 1, in one preferred variation at least one remote device 10 that the wearable computing device transmits data to is accessed by at least one of A) a family member 9 of the user, and B) a supervisor 9 of the user. In one variation, family members 9 include but are not limited to at least one of parents, grandparents, and siblings of the user. In one variation, supervisors 9 of the user 11 may include but are not limited to teachers, doctors, caretakers, and counselors. In one preferred variation, the wearable computing device transmits data to the remote computing device that is related to one or more of 1) the physical health of the user, 2) the mental health of the user, 3) the academics of the user, and 4) athletics the user 11 is involved in. Mental health may include emotional state, emotional health, ability to cope with situations in the user's life, mental illnesses, mental disabilities, and any other suitable component of one or more of the user's mental health and the user's mental well being. In a preferred variation, one or more of parents, teachers, doctors, counselors, other family members 91, and other supervisors 9 can track and analyze data related to the user's health and performance in order to better care for one or more of 1) the physical health of the user, 2) the mental health of the user, 3) the academics of the user, and 4) athletics the user 11 is involved in. In another preferred variation, the wearable computing device is adapted to transmit data 8 to at least one remote device 10 that can help at least one of A) a family member 9 of the user, and B) a supervisor 9 of the user 11 care for the both the physical health of the user 11 and the emotional health of the user, as well as at least one of I) the academics of the user, and II) athletics the user 11 is involved in. The wearable computing device may, however, transmit any suitable data used for any suitable purpose by any suitable individuals. The wearable computing device may, however, not transmit any data intended for external individuals. The wearable computing device may, however, not transmit any data.

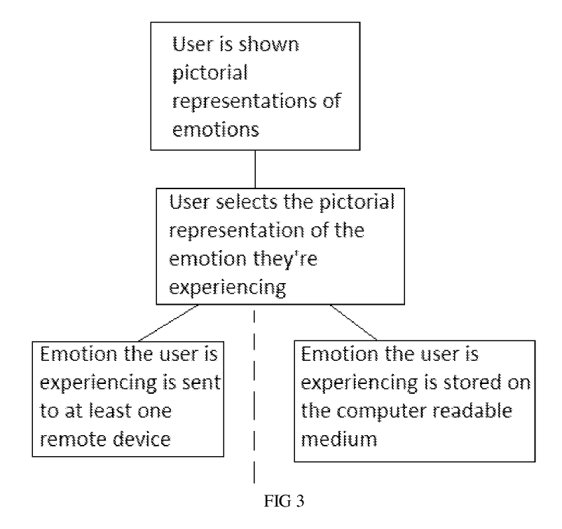

As shown in FIG. 2, in one preferred variation of the system of the first preferred embodiments, the software shows the user 11 a prompt, where the prompt 13 allows the user 11 to select one or more pictorial representation 12 of emotions the user 11 is feeling. Preferably the pictorial representations 12 depict human emotions in an illustrated form. In one preferred variation, the pictorial representations 12 depict illustrated human faces showing emotions that the user 11 is likely to one or more of inherently recognize, and learn easily. As shown in FIG. 3, in this preferred variation, the one or more emotional state selected by the user 11 is at least one of 1) stored in the computer readable medium, and 2) transmitted to a remote device. In one preferred variation, these user 11 selected emotional states are transmitted to a remote device 10 for review by at least one of A) a family member 9 of the user 11 and B) a supervisor 9 of the user. In another preferred variation, the one or more emotional states selected by the user 11 can be stored on the computer readable device for later access by at least one of the software on the wearable computing device and an external device. In this preferred variation, an external device may be plugged into the wearable computing device by any suitable means, which can include but is not limited to a USB cable. Alternatively, an external device may be wirelessly connected to the wearable computing device to access the data stored on the wearable computer medium, including but not limited to one or more user 11 selected emotional states. In another preferred variation, one or more of the wearable computing device and a remote device 10 may perform a statistical analysis on two or more user 11 selected emotional states that the user 11 selects over time. In this variation, the statistical analysis may be used to generate one or more of i) warnings transmitted to a remote device 10 than can be accessed by at least one of A) a family member 9 and B) a supervisor 9 of the user, ii) output on the screen 6 of the device that can one or more of assist and encourage the user 11 with the goal of helping the user 11 achieve healthy emotional states, iii) challenges that the user 11 may participate in through interaction with the wearable computing device. In one preferred variation, the user 11 can use the graphical user 11 interface output onto the screen 6 by the software to bring up the emotional state selection interface at any point in time that the user 11 desires. In another preferred variation, the wearable computing device may prompt 13 the user 11 at any suitable time to select their current emotional state. In another preferred variation, features of both of these variations may be combined. The one or more user 11 selected emotional states may, however, be used in any suitable manner. The wearable computing device may, however, not provide a means for the user 11 to select any emotional states.

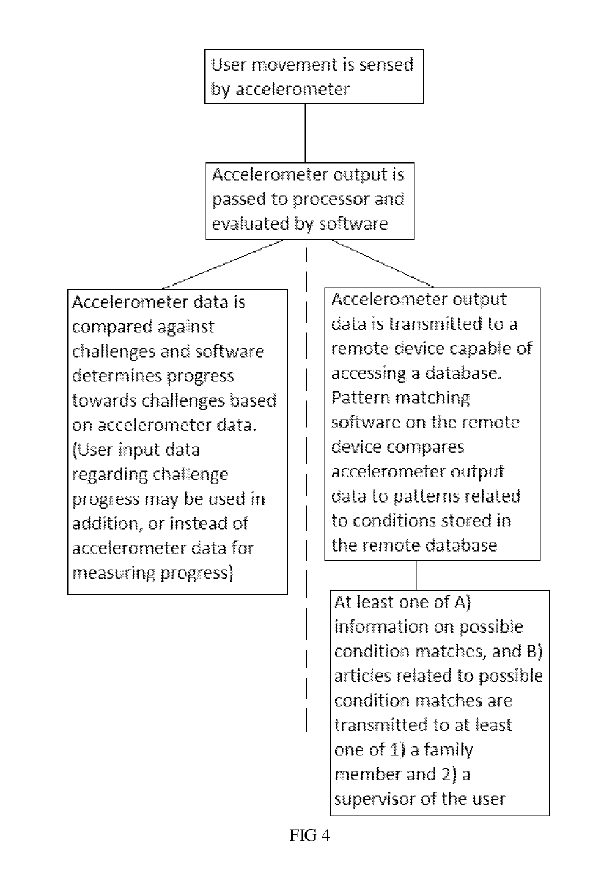

As shown in FIG. 2, in a preferred variation the wearable computing device includes an accelerometer 14 mounted inside the housing 3 and connected to one or more of the processor 1, a motherboard, and an integrated electronics circuit including the electronic components of the wearable computing device. As shown in FIG. 4, the output of the accelerometer 14 is preferably used by algorithms in the software of the wearable computing device.

As shown in FIG. 4, in one preferred variation, the wearable computing device gives the user 11 challenges to complete. These challenges are preferably designed to help the user 11 to achieve improvements in one or more of A) physical health, B) mental health, C) academics, and D) athletics the user 11 participates in. One example of a challenge would be to walk or run a given certain distance over the course of the week. Another example of a challenge would be to do a certain number of push-ups in a week. Another example of a challenge would be to read a certain number of pages in a week. Another example of a challenge would be to call two friends and set up an activity to participate in. Another example of a challenge would be for the user 11 to solve a puzzle or research the answer to a question. As shown in FIG. 4, in one preferred variation the output of the accelerometer 14 is used by the software on the wearable computing device to track the progress of the user 11 in accomplishing a challenge. In one variation, the wearable computing device may provide one or more of encouragement, aide to the user 11 to assist them in completing a challenge, feedback to the user 11 related to their progress in a challenge, and transmitted data to a remote device 10 that allows at least one of A) a family member 9 and B) a supervisor 9 of the user 11 to react to the progress of the user 11 in a challenge. The wearable computing device may encourage the user 11 based on their performance, for instance telling the user 11 “Good job!,” or showing the user 11 pictorial representations 12 that are encouraging or rewarding. The wearable computing device may also encourage the user 11 to take certain activities that will help them complete a challenge, such as “If you walk 300 more steps today, you will complete your challenge,” or “If you walk home from school today, you will complete your challenge.” These messages may be in part or in whole represented pictorially. The wearable computing device may transmit data 8 to a remote device, so that the remote device 10 can output messages or information to at least one of A) a family member 9, and B) a supervisor 9 of the user, such as “The user 11 has completed 67 pushups this week,” or “The user 11 is struggling to read the number of pages in their challenge this week.” The wearable computing device may, however, have the user 11 participate in any suitable challenges. The wearable computing device may, however, give the user 11 any suitable output related to their progress in challenges. Data transmitted to a remote device 10 about the challenges may, however, be used for any suitable purpose. The wearable computing device may, however, not transmit any data about challenges the user 11 is participating in. The wearable computing device may, however, not have the user 11 participate in any challenges.

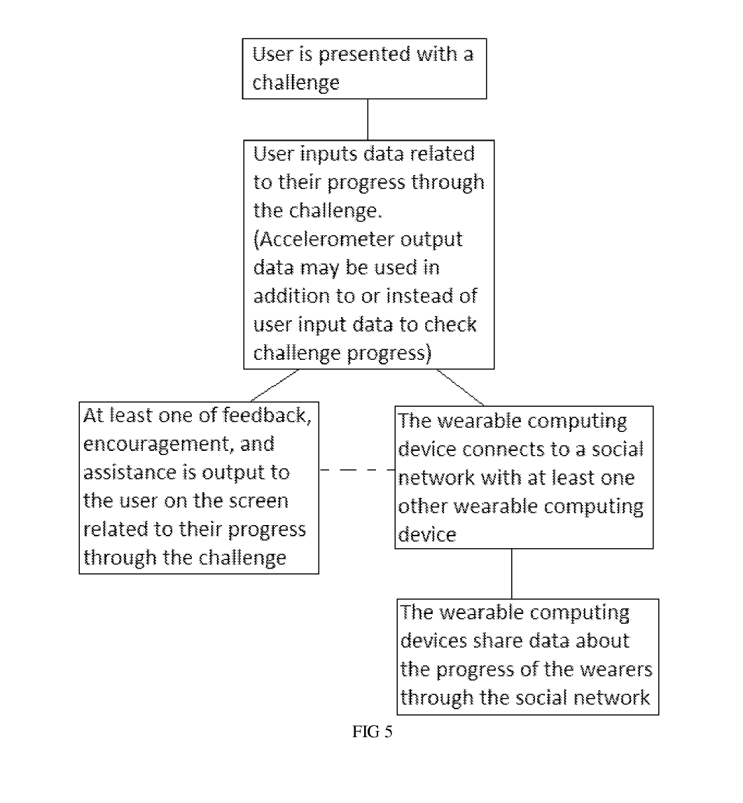

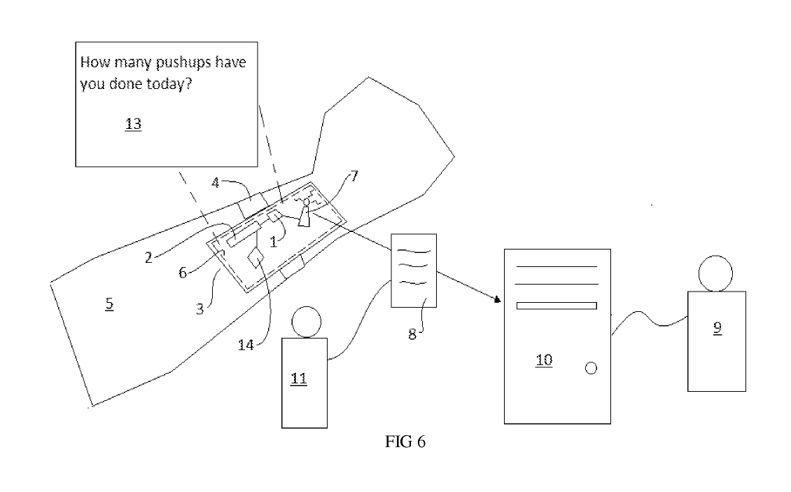

As shown in FIG. 5, in one preferred variation the wearable computing device may prompt 13 the user 11 to input information related to their progress through challenges. As shown in FIG. 6, this data may include asking the user 11 the status of their effort towards a challenge goal, such as asking a user 11 how many pushups they performed today or how many pages they read. The wearable computing device may, however, prompt 13 the user 11 for input related to their challenges in any suitable way. In another preferred variation, user 11 input related to their challenges can be combined with output from the accelerometer 14 to provide two sources of data that the software can use to track the progress of a user 11 in a challenge. In another variation, the wearable computing device may only use data input by the user 11 to track the progress of the user 11 in a challenge. The wearable computing device may not include an accelerometer 14. In another variation, the wearable computing device may only use the output of sensors in the wearable computing device to track the progress of the user 11 in a challenge. The wearable computing device may include any suitable sensors in addition to an accelerometer 14, including but not limited to magnetometers, gyroscopes, temperature sensors, heart rate monitors, GPS sensors, and any other suitable sensors.

As shown in FIG. 5, in one preferred variation, the wearable computing device may transmit data 8 to at least one remote device 10 that allows the wearable computing device to participate in a social network with at least one other wearable computing device. In one preferred variation, the progress of at least two users can be shared via the social network. The users may be shown the progress of the at least one other user 11 in at least one challenge. The users may be allowed to compete against one another via the social network. The users may be allowed to play games against each other via the social network, preferably games involving real world activities resulting in benefits to one or more of 1) the physical health of the users, 2) the emotional health of the users, 3) the academics of the users, and 4) the athletics the users are involved in. One example of the ability of the users to compete via the social network would be a competition between at least two users to do the most pushups in a week. In this example, the social network might provide data from one user's wearable computing device to the at least one other user, such as “user 11 1 has completed 97 pushups so far this week.” An example of using the social network to help the users succeed in athletics would be providing a message to the users of the social network such as “user 11 1 scored 3 goals in today's soccer game, congratulations user 11 1!” and in this example at least one other user 11 of the social network may be on the same soccer team as user 11 1. Challenges and data related to challenges may, however, be used in any suitable way on the social network. In one preferred variation, the at least two users of the social network can come up with their own challenges and challenge other users of the social network to participate in the challenge they created. This preferably works with the natural tendencies of children to challenge each other and compete against each other. Preferably the challenges can be encouraged to contain goals and processes that positively benefit the users is one or more of 1) the physical health of the users, 2) the emotional health of the users, 3) the academics of the users, and 4) the athletics the users are involved in. The social network may, however, not be used for challenges between users. In one preferred variation, the at least two users may be provided with means for sending encouraging messages to one another over the social network. The social network may, however, be used in any suitable manner. The system of the preferred embodiments may, however, not be linked to a social network at all.

As shown in FIG. 4, the wearable computing device may output data from sensors to a remote device 10 capable of accessing a remote database 15, and capable of carrying out statistical analysis on the transmitted sensor data. The transmitted sensor data may include but is not limited to accelerometer 14 data, temperature sensor data, heart rate sensor data, glucose sensor data, blood oximetry sensor data, gyroscope data, magnetometer data, time data corresponding to the sensor data, and any other suitable sensor data. In another preferred variation, the transmitted data may also include data from user 11 inputs, which can include at least one emotional state the user 11 has input, and any other suitable data the user 11 may input. Preferably the remote device 10 is adapted to carry out statistical analysis on the transmitted data and access a database that includes at least data on conditions related to one or more of physical health and mental health. In another preferred variation, the software on the wearable computing device performs statistical analysis on the data taken over time by the wearable computing device and sends the statistical analysis the the remote device 10 that is adapted to access a database that includes at least data on conditions related to one or more of physical health and mental health. The remote device 10 can preferably use pattern matching algorithms to determine conditions the user 11 is statistically likely to have based on the statistical analysis of the transmitted data. The system preferably can send information related to these possible conditions the user 11 may have to another remote device 10 which can output data to at least one of A) a family member 9 and B) a supervisor 9 of the user. In another preferred variation, information related to the possible conditions the user 11 may have is transmitted back to the wearable computing device, and the wearable computing device can perform one or more actions including but not limited to outputting data on the conditions to the user, prompting the user 11 with challenges that may improve the possible conditions the user 11 may be suffering, creating actions in the social network that may improve the possible conditions the user 11 may be suffering, prompting the user 11 to perform actions that may improve the possible conditions the user 11 may be suffering. In one preferred variation, the wearable computing device tracks physical activity levels and sleep patterns of the user 11 and transmits at least this data to the remote device 10 that is adapted to perform statistical analysis and access a database with information relating to conditions a user 11 may suffer. The wearable computing device may, however, track any suitable activities and transmit any suitable data for identifying conditions the user 11 may suffer from. The wearable computing device may, however, not transmit any data for statistical analysis and comparison to common conditions. In another preferred variation, the software on the wearable computing device performs statistical analysis of sensor data on the processor 1 and compares the analysis results to at least one database that is at least one of A) stored on computer readable memory and B) accessible by data transmission over the radio transmitter, where the software utilizes the processor 1 to compare data from the at least one database and the statistical analysis to identify conditions the user 11 may suffer within the wearable computing device. In one preferred variation, at least one of of the wearable computing device and the remote device 10 adapted to access a remote database 15 utilizes the data on the conditions the user 11 may suffer to access articles in a database related to the conditions the user 11 may suffer. Then at least one of the wearable computing device and the remote device 10 adapted to access the remote database 15 transmits one or more article related to the conditions the user 11 may suffer, if any are located, to a remote device 10 that can be accessed by at least one of A) a family member 9 of the user, and B) a supervisor 9 of the user. Preferably the at least one article is transmitted to a remote device 10 so that at least one of A) a family member 9 of the user 11 and B) a supervisor 9 of the user 11 can read information related to conditions that have been identified that the user 11 may suffer. In one variation, these articles may include scientific research articles. In another variation, these articles may include popular publication articles and articles from the internet. In another variation, these articles may include any suitable article from any suitable source with information related to the conditions identified that the user 11 may suffer. Preferably the at least one of A) a family member 9 of the user 11 and B) a supervisor 9 of the user 11 can opt out of receiving articles related to potential conditions the user 11 may suffer. In another preferred variation, both the conditions identified that the user 11 may suffer and the raw sensor data is transmitted to a remote device 10 that can be accessed by a medical professional. The system of the preferred embodiments may, however, use sensor data to identify conditions in any suitable manner. The system of the preferred embodiments may, however, not identify conditions the user 11 may suffer from at all.

In one preferred variation, the wearable computing device can track data points over time and provide the data in a format for viewing on at least one of the wearable computing device, and a separate computing device which can receive data from the wearable computing device. In this variation the data is preferably displayed in formats useful for representing data over time, including but not limited to graphs, tables, charts, journal formats, and any other suitable format for viewing data represented over time. This preferably allows one or more of I) the user, II) a family member 9 of the user, and III) a supervisor 9 of the user 11 to track the progress of the user 11 in any suitable category over time.

Preferably as much of the output provided to the user 11 as possible is provided in pictorial representations. In one preferred variation, the wearable computing device may provide alarm 5 reminders to the user. In one example, the wearable computing device may trigger an alarm 5 and display a picture of a pill to remind a user 11 to take medication. In another example, the wearable computing device may show a pictorial representation 12 of a test to remind the user 11 they have a test coming up. The users of the device are preferably intended to be at least one of children and the developmentally disabled, so making as many outputs of the device as possible in easy-to-understand pictorial form benefits these users. The wearable computing device may, however, provide any suitable reminders and alarm 5s. The wearable computing device may, however, represent information to the user 11 in any suitable manner.

In a preferred variation, the wearable computing device provides positive reinforcement for activities the user 11 carries out that can benefit the user 11 in at least one of 1) the physical health of the users, 2) the emotional health of the users, 3) the academics of the users, and 4) the athletics the users are involved in. Preferably, the positive reinforcement is given irregularly, as irregular reinforcement is psychologically more effective in motivating the user. The wearable computing device may, however, provide any suitable reinforcement in any suitable manner. The wearable computing device may, however, not provide any reinforcement.

In a preferred variation of the wearable computing device, the wearable computing device further includes a GPS location sensing chipset and software designed to determine the location of the device. In this preferred variation, the device transmits its location to at least one remote device 10 connected to the social network. At least one additional wearable computing device also transmits its location to the social network. If at least one of the wearable computing devices and the at least one remote device 10 determines that another wearable computing device is nearby, it may alarm 5 the user. In a preferred variation, it may vibrate and display an image of the user 11 of the at least one additional wearable computing device. In this preferred variation, the at least two wearable computing devices may share data through the social network, where the data may include location, activity data, sports data, social data, data on challenges the user 11 may be participating in, and any other suitable data. The data may be at least one of shared with and downloaded by one or more of friends, supervisors 9, teammates, coaches, and any other suitable parties. The wearable computing device may, however, not have any means for determining proximity to other wearable computing device users. The wearable computing device may, however, share any suitable data with nearby wearable computing devices. The wearable computing device may, however, not share any data with nearby wearable computing devices. The wearable computing device may, however, have any suitable means for detecting its location. The wearable computing device may, however, not have any means for sensing its location.

As a person skilled in the art will recognize from the previous detailed description and from the figures and claims, modifications and changes can be made to the preferred embodiments of the invention without departing from the scope of this invention defined in the following claims.

We Claim:

1) A wearable computing device comprising a processor; computer readable memory connected to the processor, wherein the computer readable memory is adapted for reading and use by the processor; software code stored in the computer readable memory; a housing enclosing the processor and computer readable memory; a wrist band attached to the housing and adapted to releasably attaching the housing to the arm of a user; a screen adapted to display output intended to interact with the user and mounted to the top of the housing, wherein the screen is further adapted to sense touch input from the user; a radio transmitter attached to the housing, wherein the radio transmitter is adapted to transmit data to at least one remote device, wherein the software is adapted to transmit data that is related to at least one of A) the health of the user, B) the mental well-being of the user, C) the success of the user in sports, and D) the success of the user in academics, wherein the transmitted data is further adapted to assist at least one of 1) a family member of the user, and 2) a supervisor of the user in caring for at least one of A) the health of the user, B) the mental well-being of the user, C) the success of the user in athletics, and D) the success of the user in academics.

2) The wearable computing device of claim 1, wherein the transmitted data is adapted to assist at least one of 1) a family member of the user, and 2) a supervisor of the user in caring for each of A) the health of the user, B) the mental well-being of the user, and at least one of i) the success of the user in academics and ii) the success of the user in athletics.

3) The wearable computing device of claim 1, wherein the software is adapted to show pictorial depictions of human emotions to the user, wherein the user can select the pictorial representation of the emotion they are experiencing, wherein the processor at least one of A) sends the emotion the user is experiencing to a remote device with the radio transmitter, and B) stores the emotion the user is experiencing in the computer readable memory.

4) The wearable computing device of claim 2, wherein the software is adapted to show pictorial depictions of human emotions to the user, wherein the user can select the pictorial representation of the emotion they are experiencing, wherein the processor at least one of A) sends the emotion the user is experiencing to a remote device with the radio transmitter, and B) stores the emotion the user is experiencing in the computer readable memory.

5) The wearable computing device of claim 1, wherein the software is further adapted to provide the user challenges related to at least one of A) athletics and B) academics, wherein the software is further adapted to prompt the user to input information related to the challenges over the time period of the challenges, wherein the software is further adapted to change the output shown to the user on the screen based on the user input information to at least one of 1) aid the user in the completion of the challenges, 2) provide motivation to the user in the challenges, and 3) reward the user.

6) The wearable computing device of claim 1, wherein the wearable computing device further comprises an accelerometer, wherein the software is further adapted to track the physical activity of the user by taking into account the output of the accelerometer, wherein the software is further adapted to provide the user challenges related to at least one of A) athletics and B) academics, wherein the software is further adapted to react to the output of the accelerometer by showing the user output on the screen based to at least one of 1) aid the user in the completion of the challenges, 2) provide motivation to the user in the challenges, and 3) reward the user.

7) The wearable computing device of claim 5, wherein the wearable computing device further comprises an accelerometer, wherein the software is further adapted to track the physical activity of the user by taking into account the output of the accelerometer, wherein the software is further adapted to provide the user challenges related to at least one of A) athletics and B) academics, wherein the software is further adapted to react to the output of the accelerometer by showing the user output on the screen based to at least one of 1) aid the user in the completion of the challenges, 2) provide motivation to the user in the challenges, and 3) reward the user.

8) The wearable computing device of claim 7, wherein the software is further adapted to send data to the at least one remote device related to at least one of A) the user input during the timeline of the challenge, B) the accelerometer output, and C) the progress of the user in the challenges.

9) The wearable computing device of claim 8, wherein the software is adapted to show pictorial depictions of human emotions to the user, wherein the user can select the pictorial representation of the emotion they are experiencing, wherein the processor at least one of A) sends the emotion the user is experiencing to a remote device with the radio transmitter, and B) stores the emotion the user is experiencing in the computer readable memory.

10) The wearable computing device of claim 2, further comprising an accelerometer, wherein the software is further adapted to track the physical activity of the user by taking into account the output of the accelerometer, wherein the software is further adapted to provide the user challenges related to at least one of A) athletics and B) academics, wherein the software is further adapted to prompt the user to input information related to the challenges over the time period of the challenges, wherein the software is further adapted to change the output shown to the user on the screen based on at least one of i) the user input information and ii) the output of the accelerometer to at least one of 1) aid the user in the completion of the challenges, 2) provide motivation to the user in the challenges, and 3) reward the user.

11) The wearable computing device of claim 10, wherein the software is adapted to show pictorial depictions of human emotions to the user, wherein the user can select the pictorial representation of the emotion they are experiencing, wherein the processor at least one of A) sends the emotion the user is experiencing to a remote device with the radio transmitter, and B) stores the emotion the user is experiencing in the computer readable memory.

12) The wearable computing device of claim 8, wherein the at least one remote device is connected to a social network of at least one other wearable computing device, wherein the user progress in the challenges can be compared between the users in the social network, wherein the relative progress through the challenges of the users in the social network is output to the users on the screen at least one of A) when the user requests to see the relative progress, and B) at points in the time period of the challenges.

13) The wearable computing device of claim 5, wherein the software is further adapted to send data to the at least one remote device related to at least one of A) the user input during the timeline of the challenge and B) the progress of the user in the challenges, wherein the at least one remote device is connected to a social network of at least one other wearable computing device, wherein the user progress in the challenges can be compared between the users in the social network, wherein the relative progress through the challenges of the users in the social network is output to the users on the screen at least one of A) when the user requests to see the relative progress, and B) at points in the time period of the challenges.

14) The wearable computing device of claim 12, wherein the software is adapted to show pictorial depictions of human emotions to the user, wherein the user can select the pictorial representation of the emotion they are experiencing, wherein the processor at least one of A) sends the emotion the user is experiencing to a remote device with the radio transmitter, and B) stores the emotion the user is experiencing in the computer readable memory.

15) The wearable computing device of claim 3, further comprising an accelerometer, wherein the software is further adapted to track the physical activity of the user by taking into account the output of the accelerometer, wherein the software is further adapted to take statistics over time using data from at least one of A) the output of the accelerometer and B) the current emotional state of the user, wherein the statistics are compared against data stored in a remote database by a remote device, wherein the wearable computing device uses the radio transmitter to communicate with the remote device capable of processing data from a stored remote database, wherein the remote device performs pattern matching between the statistics taken over time and the data stored on the remote database, wherein the data stored on the remote database relates to at least one of 1) physical health conditions, and 2) mental health conditions, wherein the pattern matching performed by the remote device identifies possible conditions from at least one of 1) physical health conditions, and 2) mental health conditions that may match the statistics taken over time, wherein the conditions identified as possible matches are transmitted by the remote device to at least one of i) the wearable computing device, and ii) another remote device that can be accessed by at least one of I) a family member of the user, II) a supervisor of the user, and III) a doctor of the user.

16) The wearable computing device of claim 15, wherein at least one of A) the wearable computing device and B) the remote device capable of processing data from a stored remote database is further adapted to access articles that may be related to the conditions identified as possible matches, wherein at least one of the articles that may be related to the conditions identified as possible matches is sent to a remote devicel that can be accessed by at least one of I) a family member of the user, II) a supervisor of the user, and III) a doctor of the user.

17) The wearable computing device of claim 14, wherein the software is further adapted to take statistics over time using data from at least one of A) the output of the accelerometer and B) the current emotional state of the user, wherein the statistics are compared against data stored in a remote database by a remote device, wherein the wearable computing device uses the radio transmitter to communicate with the remote device capable of processing data from a stored remote database, wherein the remote device performs pattern matching between the statistics taken over time and the data stored on the remote database, wherein the data stored on the remote database relates to at least one of 1) physical health conditions, and 2) mental health conditions, wherein the pattern matching performed by the remote device identifies possible conditions from at least one of 1) physical health conditions, and 2) mental health conditions that may match the statistics taken over time, wherein the conditions identified as possible matches are transmitted by the remote device to at least one of i) the wearable computing device, and ii) another remote device that can be accessed by at least one of I) a family member of the user, II) a supervisor of the user, and III) a doctor of the user.

18) The wearable computing device of claim 17, wherein at least one of A) the wearable computing device and B) the remote device capable of processing data from a stored remote database is further adapted to access articles that may be related to the conditions identified as possible matches, wherein at least one of the articles that may be related to the conditions identified as possible matches is sent to a remote devicel that can be accessed by at least one of I) a family member of the user, II) a supervisor of the user, and III) a doctor of the user.

19) The wearable computing device of claim 3, further comprising an accelerometer, wherein the software is further adapted to track the physical activity of the user by taking into account the output of the accelerometer, wherein the software is further adapted to take statistics over time using data from at least one of A) the output of the accelerometer and B) the current emotional state of the user, wherein the statistics are compared against data stored in a database stored in the computer readable memory, wherein the software code performs pattern matching between the statistics taken over time and the data stored in the database, wherein the data stored in the database relates to at least one of 1) physical health conditions, and 2) mental health conditions, wherein the pattern matching performed by the remote device identifies possible conditions from at least one of 1) physical health conditions, and 2) mental health conditions that may match the statistics taken over time, wherein the conditions identified as possible matches are transmitted by radio transmitter to at least one of i) the wearable computing device, and ii) another remote device that can be accessed by at least one of I) a family member of the user, II) a supervisor of the user, and III) a doctor of the user.
